(19) United States
(12) Patent Application Publication
(10) Pub. No.: US 2014/0156368 A1
(43) Pub. Date: Jun. 5, 2014

(54) SYSTEMS AND METHODS FOR PROVIDING CREDIT TO FINANCIAL SERVICE ACCOUNTS

(71) Applicants: Andrew Wen, Palo Alto, CA (US); Matthew Stern, Arlington, VA (US)

(72) Inventors: Andrew Wen, Palo Alto, CA (US); Matthew Stern, Arlington, VA (US)

(73) Assignee: Captial One Financial Corporation, McLean, VA (US)

(21) Appl. No.: 14/094,483

(22) Filed: Dec. 2, 2013

Related U.S. Application Data
(60) Provisional application No. 61/732,596, filed on Dec. 3, 2012.

(51) Int. Cl. G06Q 30/02

(52) U.S. Cl. CPC G06Q 30/0215
USPC 705/14.17

(57) ABSTRACT

A system and method is provided for redeeming coupons to credit a customer's financial service account without sharing the customer's restricted information with merchants. The system and method may include a financial service provider receiving merchant transaction information from a merchant that reflects sale transactions associated with the merchant over a period of time. The financial service provider may compare the merchant transaction information with financial service accounts transaction information associated with financial service accounts provided by the financial service provider. Additionally, the financial service provider may identify a common transaction between the merchant transactions and the financial service accounts transactions based on one or more unique identifiers, determine the common transaction meets a predetermined credit requirement, and identify a customer's financial service account corresponding to the common transaction. Furthermore, the financial service provider may provide credit to the customer's financial service account based on the predetermined requirement.

### PRIORITY CLAIM

This disclosure claims priority under 35 U.S.C. §119 to U.S. provisional patent application No. 61/732,596, filed on Dec. 3, 2012, and entitled “Systems and Methods for Providing Credit to Financial Service Accounts,” which is incorporated herein by reference in its entirety.

### TECHNICAL FIELD

The present disclosure relates generally to financial service account management technologies and, in particular, to methods and systems for providing credit to financial service accounts.

### BACKGROUND

Coupons are commonly used in the marketplace to provide a variety of incentives for customers to use a given product or service. In a typical scenario, a coupon supplier, such as a merchant, will supply and distribute the coupons, and customers will redeem them upon making a purchase with the merchants. Merchants often provide requirements for using the coupons that inform customers how to redeem coupons. For instance, a coupon might specify that customers will receive a fixed amount discounted off their total purchase if they spend above a certain amount of money at the merchant's store. In another example, a manufacture coupon could give customers a discount towards the purchase of a product and/or service if they buy a specific brand or type of service offered by the manufacturer, regardless of where purchased.

Customers may receive coupons in the mail or through electronic mechanisms, such as email, SMS messages, or a mobile device application (mobile application). To redeem a coupon, merchants may require a customer to be physically present when purchasing items covered by the coupon at the merchant's location. A customer may turn over a physical copy of the electronically-received coupon to the merchant or provide a tracking number associated with the coupon. The merchant then provides the coupon discount to the customer at the time of sale. Therefore, as with typical coupons, the customer receives the monetary discount when the purchase is made at the point of sale location.

### SUMMARY

Consistent with the disclosure, a system is provided for providing credit to financial service accounts. In one embodiment, the system may be associated with a financial service provider or an entity that provides information and/or services to a financial service provider. The system may include a processor configured to receive from a merchant (e.g., via a merchant system), merchant transaction information reflecting sale transactions associated with the merchant over a period of time. The processor may execute stored software instructions that compare the merchant transaction information with financial service accounts transaction information associated with financial service accounts provided by the financial service provider. Additionally, the processor may be configured to identify a common transaction between the merchant transactions and the financial service accounts transactions based on one or more unique identifiers and determine that the common transaction meets one or more predetermined credit requirements. The processor may be further configured to identify a customer's financial service account corresponding to the common transaction and to provide a credit to the account based on whether the credit requirements are met. Moreover, the processor may be configured to generate and provide a notification of the applied credit to the customer associated with the financial service account, such as, for example, in a statement, message, or other form of notification. The processor may provide the notification using one or more delivery mechanisms, such as email, SMS messaging, web site information, mobile applications, etc.

Consistent with the disclosure, a method is disclosed for providing credit to financial service accounts. In one embodiment, the method may be performed by one or more processors configured to execute software instructions. The method may include receiving from a merchant (e.g., via a merchant system), merchant transaction information reflecting sale transactions associated with the merchant over a period of time. The method may also include comparing the merchant transaction information with transaction information associated with financial service accounts provided by the financial service provider. Additionally, the method may include identifying a common transaction between the merchant transactions and the transaction information based on one or more unique identifiers. The method may include determining that the common transaction meets one or ore predetermined credit requirements. Further, the method may include identifying a customer's financial service account corresponding to the identified common transaction and providing a credit to the identified account if/when the credit requirement(s) is met. Moreover, the method may include generating a notification of the applied credit in, for example, a statement, message, or other form of communication with the customer. The method may also include providing the notification to the customer. In one embodiment, providing the notification may include one or more delivery mechanisms, such as email, SMS messaging, web site information, mobile applications, etc.

Consistent with the disclosure, a device is provided for receiving notification of a credit to a financial service account. The device may include a processor and a memory storing instructions that are executed by the processor. In one embodiment, the processor may be configured to receive a financial offer of a specified value, the financial offer including redemption requirements. The processor may also be configured to receive a notification of a credit applied to a first financial account associated with a financial service provider based on a qualifying purchase of an item from a merchant using the first financial account. The notification may include information that is generated based on a comparison between merchant transaction information provided by the merchant with financial service accounts transaction provided by the financial service provider. Additionally, the notification may include information generated based on: an identification of a common transaction between the merchant transaction and the financial service accounts transactions using on one or more unique identifiers, a determination that the common transactions meet redemption requirements associated with the offer, and an identification of the first financial service account based on the identification of the common transactions. In certain embodiments, the processor may be configured to display the notification on a display associated with the device. In one aspect, the notification may be in the form of an electronic version of a financial statement relating to the first financial service account. In other aspects, the notification may in the form of a message that indicates the amount of credit applied to the first financial account.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various embodiments and aspects of the disclosed embodiments, and together with the description, serve to explain the principles of the disclosed embodiments.

FIG. 1 illustrates an exemplary system for providing credit to financial service accounts, consistent with disclosed embodiments.

FIG. 2 illustrates another exemplary system for credit to financial service accounts, consistent with disclosed embodiments.

FIG. 3 depicts a flowchart of an exemplary method for providing credit to financial service accounts, consistent with disclosed embodiments.

FIG. 4 depicts a flowchart of an exemplary method for providing a coupon offer to a customer, consistent with the disclosed embodiments.

FIG. 5 depicts a flowchart of an exemplary method for receiving sale transaction information from a merchant, consistent with the disclosed embodiments.

FIG. 6 depicts a flowchart of an exemplary method for verifying whether a customer met coupon requirements, consistent with the disclosed embodiments.

FIG. 7 depicts a flowchart of an exemplary method for providing credit to a financial service account, consistent with the disclosed embodiments.

FIG. 8 depicts a flowchart of an exemplary method for receiving credit to a financial service account, consistent with certain disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

It is to be understood that the disclosed steps or processes disclosed herein are not limited to being performed in the order described, but may be performed in any order, and that some steps may be omitted, consistent with the disclosed embodiments. For ease of discussion, disclosed embodiments will be described below in the context of credit card transactions. It is to be understood, however, that embodiments are not limited credit card transaction and may be used in conjunction with any customer account.

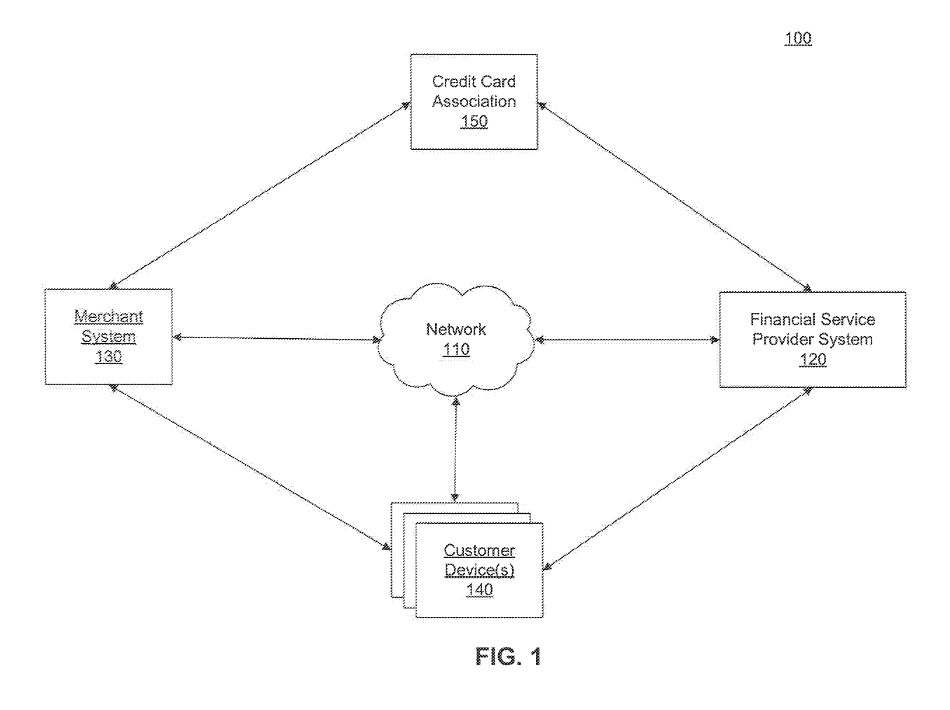

FIG. 1 is a diagram illustrating an exemplary system 100 for providing credit to financial service accounts. System 100 may include a network 110, financial service provider system 120, merchant system 130, customer device(s) 140, and credit card association 150. The components and arrangement of the components described in FIG. 1, however, may vary.

Network 110 may be any type of network configured to provide communications between components of system 100. For example, network 100 may be any type of network (including infrastructure) that provides communications, exchanges information, and/or facilitates the exchange of information, such as the Internet, a Local Area Network, or other suitable connection(s) that enables system 100 to send and receive information between the components of system 100 (shown and not shown).

Financial service provider system 120 may be a system associated with a financial service provider providing and/or managing financial service accounts for one or more users, such as a bank, credit union, credit card company, etc. In one embodiment, financial service provider system 120 may include one or more computing systems that are located at a central location or may include computing devices that are distributed (locally or remotely). In one example, financial service provider system 120 may include a server(s) configured to execute software instructions stored in one or more memory devices to perform one or more operations consistent with the disclosed embodiments.

The financial service provider may provide different financial service products for customers. For example, in one aspect, the financial service provider may provide and manage credit card accounts for one or more users. In certain aspects, each credit card account may be associated with a customer's financial service account managed by the financial service provider (via, e.g., financial service provider system 120). Financial service accounts may include, for example, credit card accounts, checking accounts, savings accounts, loans, investment accounts. Financial service provider system 120 may execute instructions that monitor customer purchasing transactions associated with financial service accounts, such as credit card accounts. In certain aspects, financial service provider system 120 may be configured to create financial service accounts transaction information that reflect transactions of purchases made using financial service accounts. For example, financial service provider system 120 may execute software instructions that determine and provide credit and/or deductions to a customer's financial service account based on the customer's purchases/transactions using financial service account(s) provided by the financial service provider to the customer.

Merchant system 130 may include one or more systems that are associated with a merchant that sells products and/or services. A merchant may be an entity that sells products or services at physical locations (brick and mortar locations) and/or does so using known e-commerce mechanisms, such as over the Internet. For instance, merchants may include department stores, retail shops, grocery stores, pharmacy stores, and specialty stores. Additionally, merchant system 130 may include processors and software instructions that provide and manage one or more websites or mobile applications that sell products and/or services. Merchant system 130 may be configured to perform financial transaction processes, such as receiving, processing, and handling purchase transactions, payment processes, etc. associated with the sale of goods and/or services provided by the associated merchant. In some aspects, merchant system 130 may include computing devices that may include back and/or front-end computing components that store consumer transaction data and execute software instructions to perform operations consistent with the disclosed embodiments, such as computers that are operated by employees of the associated merchant (e.g., back-office systems, etc.).

Customer device 160 may be one or more electronic devices, such as a laptop or desktop computer, mobile phone (e.g., smartphone), tablet, and the like. Customer device 160 may be associated with a customer of a financial service provider, such as the provider associated with financial service provider system 120. In one aspect, customer device 160 may be capable of receiving information through network 110, using known information delivery mechanisms, such as email, etc. According to some embodiments, a customer may use customer device 160 to make purchases at point of sale locations of a merchant (via, e.g., near-field communication). In other embodiments, a customer may use customer device 160 to make online purchase (via, e.g., accessing an e-commerce website of a merchant over the Internet).

Credit card association 150 may be one or more financial service entities that provide infrastructure to support financial service providers in issuing and processing debit and credit cards, or other forms of credit cards and accounts, such as VISA® or MasterCard®. Credit card association 150 may include processor(s) and memory device(s) that collectively enable software instructions to be executed to perform operations consistent with disclosed embodiments. Credit card association 150 may be associated with the financial service provider relating to provider 120, or credit card association 150 may be an independent entity. For example credit card association 150 may include a credit card infrastructure, and financial service provider system 120 may be associated with a bank that issues a VISA® type credit card. In some embodiments, the operations and functionality of association 150 may be performed by financial service provider system 120 such that financial service provider system 120 may provide the infrastructure and issue a VISA® type credit card. Each credit card may be associated with a customer's financial service account with the financial service provider associated with financial service provider system 120.

In one aspect, disclosed processes can be performed without sharing restricted information between merchant system 130 and financial service provider system 120. For example, regulations may restrict the manner of sharing and/or type of information that may be shared between merchants and financial service providers, such as the name, primary account number, or identity of a person who purchased products or services from a merchant. According to some embodiments, restricted information may be sent through a first private network between merchant system 130 and credit card association 150 and a second private network between credit card association 150 and financial service provider system 120. Merchant system 130, however, may be prohibited from sending the restricted information directly to financial service provider system 120 over network 110. Less restricted information may be sent directly from merchant system 130 to financial service provider system 120. For instance, merchant system 130 may periodically send transaction information to financial service provider system 120 over network 110. The transaction information may include information reflecting purchase transactions that occurred over a period of time (e.g., daily, weekly, hourly, etc.). The transaction information may include, for example, the merchant's identification, the amount of each purchase, the time and date of each purchase, the identification of the products or services purchased, etc. According to some embodiments, however, the transaction information may not include the identity, name, or primary account number of the customers who made the purchases.

Aspects of the disclosed embodiments perform processes that enable a financial service provider (or other entity) to determine the identity of customers of the financial service provider who made purchases at the merchant without requiring merchant system 130 to share restricted customer identification information (e.g., financial service account information) with financial service provider system 120. These and other aspects of the disclosed embodiments are explained herein.

It is to be understood that the configuration and boundaries of the functional building blocks of system 100 has been defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein.

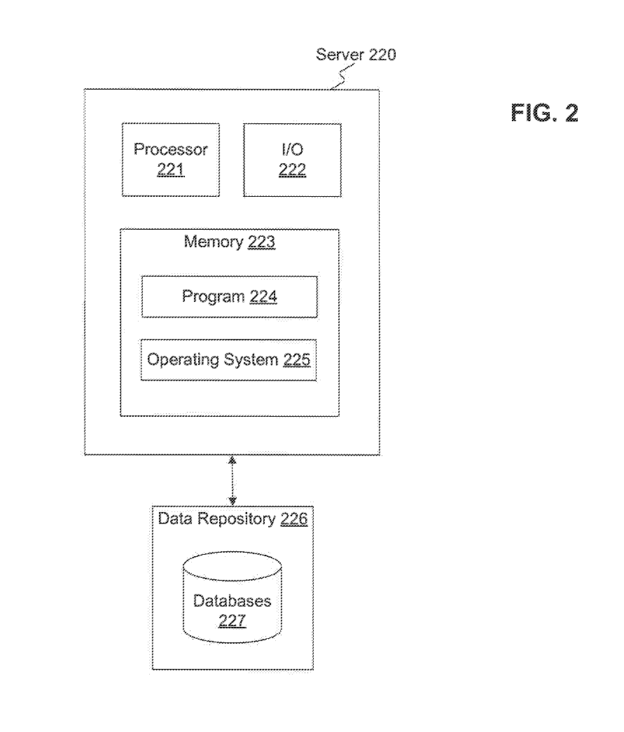

FIG. 2 shows an exemplary server 220 for implementing embodiments consistent with the present disclosure. Variations of server 220 may be used by financial service provider system 120, merchant system 130, customer devices(s) 140, and/or credit card association 150. In one embodiment, server 220 may include one or more processors 221, one or more memories 223, and one or more input/output (I/O) devices 222. In some embodiments, server 220 may take the form of a general purpose computer, a mainframe computer, or any combination of these components. Server 220 may be standalone, or it may be part of a subsystem, which may be part of a larger system.

Processor 221 may include one or more known processing devices, such as a microprocessor from the Pentium™ or Xeon™ family manufactured by Intel™, the Turion™ family manufactured by AMD™, or any of various processors manufactured by Sun Microsystems.

Memory 223 may include one or more storage devices configured to store instructions used by processor 221 to perform functions related to disclosed embodiments. For example, memory 223 may be configured with program 224 that performs several functions when executed by processor 221. The disclosed embodiments are not limited to separate programs or computers configured to perform dedicated tasks. For example, memory 223 may include a single program 224 that performs the functions of the server 120, or program 224 could comprise multiple programs. Additionally, processor 221 may execute one or more programs located remotely from server 220. For example, financial service provider system 120 may access one or more remote programs that, when executed, perform functions related to disclosed embodiments.

Memory 223 may also be configured with operating system 225 that performs several functions well known in the art when executed by server 220. By way of example, the operating system may be Microsoft Windows™, Unix™, Linux™, Solaris™, or some other operating system. The choice of operating system, and even the use of an operating system, is not critical to any disclosed embodiment.

I/O devices 222 may be one or more devices configured to allow data to be received and/or transmitted by server 220. I/O devices 222 may include one or more digital and/or analog communication devices that allow server 220 to communicate with other machines and devices, such as customer devices 140.

Server 220 may also be communicatively connected to one or more data repositories 226 as shown in FIG. 2. Server 220 may be communicatively connected to data repositories 226 through network 110. Data repository 226 may include one or more files or databases 227 that store information and are accessed and/or managed through server 220. By way of example, databases 227 may be Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, financial service provider 110 may include data repository 226. Alternatively, data repository 226 may be located remotely from financial service provider 110.

According to some embodiments, customer purchase transactions using credit cards may be monitored by server 220, through network 110, and create financial service accounts transaction information. For example, server 220 may provide credit and deductions to a customer's financial service account based on the customer's purchases and transactions. Therefore, a customer's financial service accounts transaction information may be associated with the customer's financial service accounts provided by financial service provider system 120

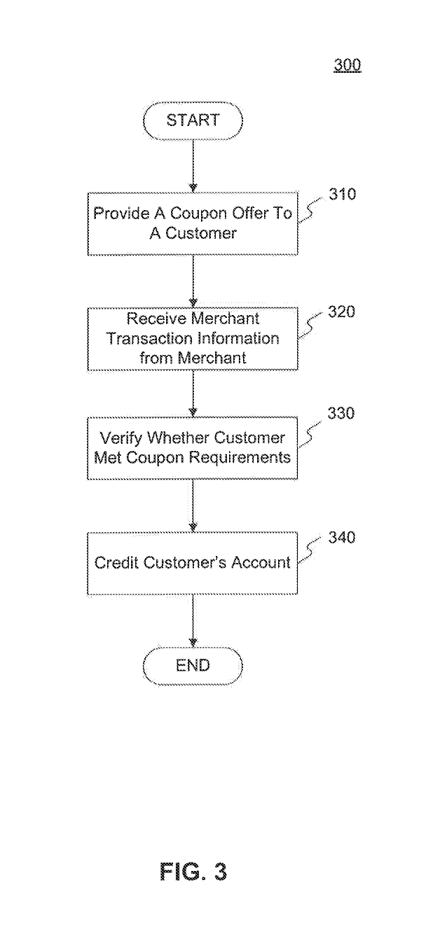

FIG. 3 is a flow diagram 300 of an exemplary method for providing credit to financial service accounts, consistent with disclosed embodiments. The method, as well as any or all of the individual steps therein, may be performed by any one or more of financial service provider system 120, merchant system 130, and/or credit card association 150. For exemplary purposes, FIG. 2 is disclosed as being performed by financial service provider system 120.

In step 310, financial service provider system 120 may generate and provide a coupon offer to a customer. The coupon may be a financial instrument that provides a discount on the sale price of a product or service. Server 220 may generate the coupon offer for financial service provider system 120. Alternatively, merchant system 130, credit card association 150, or another system associated with another entity may provide the coupon offer to a customer or to financial service provider system 120 for provision to the customer. The coupon offer may invite the customer to make a purchase from merchant system 130 and receive a deduction with that purchase.

In one example, server 220 may receive merchant transaction information from merchant system 130 in step 320. This information may be sent directly from merchant system 130 or through another system or entity. In one aspect, transaction information may include: merchant's identification, the amount of each purchase, the time and date of each purchase, the stock unit or identification number of the products or services purchased and card authorization code.

At step 325, server 220 may identify transactions from the merchant transaction information that correspond with transactions reflected in financial service provider transaction information stored in database repository 226. Data repository 226 may include transaction information relating to customers of financial service provider system 120, such as information received from credit card association 150 as part of authorizing a credit card purchase by the customer at a merchant. In some embodiments, the financial service provider transaction information may include all transactions performed by each customer of the financial service provider for each financial service product provided to those customers. The financial service transaction information may be configured in database 227 such that it is searchable and may be filtered by server 220 or database repository 226. The financial service transaction information may be configured with fields that include each financial account transaction: financial account identification data, timestamp data (when the transaction occurred), merchant identifier data, amount of purchase data, product or service identification data, and primary account number.

In one aspect, server 220 may compare the merchant transaction information with financial service provider transaction information and identify corresponding transactions between the two. Server 220 may identify the corresponding transaction using one or more common substantially unique identifiers. A unique identifier may be, for example, a combination of merchant identifier, timestamp, amount of transaction, and card authorization code associated with transaction data.

Server 220 may also use the merchant transaction information to verify whether the customer met the coupon requirements (step 330). Server 220, in step 340, may identify the customer's financial service account associated with a qualifying transaction and credit the account based on the coupon amount.

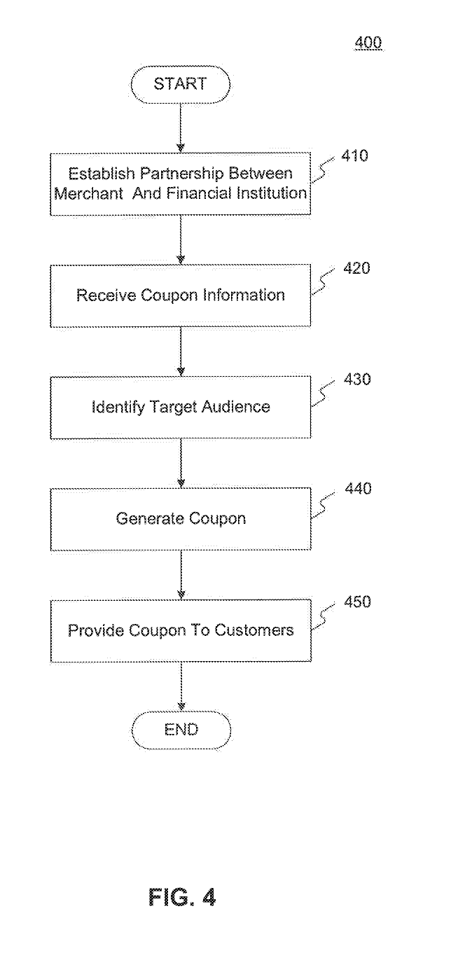

FIG. 4 shows an exemplary process 400 for providing coupon(s) to customer(s) consistent with the disclosed embodiments. In order to provide a coupon offer to a customer, the financial service provider associated with provider 120 and merchant system 130 may establish a partnership, as shown by step 410 in FIG. 4. For example, the two entities may agree to distribute and redeem the same coupons. For instance, an agreement that the coupons provided to the customers will be valid with merchant system 130 and that the customers will receive a credit from financial service provider system 120. Server 220 may receive notification of this partnership. In other aspects, financial service provider system 120 may also form relationships with a product/service provider that provides certain products or services that are sold by one or more merchants. In this way, financial service provider system 120 may provide coupons for specific products and/or services that may be redeemed when the products/services are purchased at one or more different merchant locations (physically or electronically).

In step 420, server 220 may receive the coupon information (step 420). The coupon information may include, for example, one or more credit/redemption requirements. The credit requirements may be predetermined and limit the coupon to specific stores, products, minimum spending thresholds, etc., and specify the amount of credit for a qualifying purchase. For example, a coupon may require customers to spend $100 at store X in order to receive $10 off the total purchase. Alternatively, a coupon may require a customer to purchase a specific product or service at any store location in order to receive $10 off the purchase of the product or service. Merchant system 130 or another entity or system may generate and provide the predetermined credit requirement to server 220 through network 110. Alternatively, server 220 or another component of financial service provider system 120 may generate the predetermined credit requirements.

Financial service provider system 120, merchant system 130, credit card association 150, and/or another system or entity may determine which coupons are distributed to which customers. For example, in some embodiments, server 220 may determine which customers are to receive the coupons (step 430) according to factors including, but not limited to, customers' residence location, where they frequently shop, their annual income, whether they have children, etc. Server 220 may determine the various factors in order to target specific customers and fulfill marketing strategies. In other embodiments, merchant system 130 or credit card association 150 may determine which customers are to receive the coupons.

Server 220 may generate the coupons (step 440) and provide them to the customers (step 450). In some embodiments, server 220 may generate electronic coupons that are sent through network 110 to customer devices 140. Alternatively or additionally, server 220 may generate physical coupons and send them through the mail. Merchant system 130, credit card association 150, or another party may also generate the coupons and provide them to customer devices 140. Customers may receive the coupons through customer devices 140. Specifically, customer devices 140 may be configured to receive electronic coupons via email, text, or mobile apps. Customer devices 140 may also be configured to access websites describing the coupons. Alternatively or additionally, a customer associated with customer devices 140 may receive paper coupons through the mail, for example. The coupons provided to the customers may include the predetermined credit requirements for the coupons.

Customers may use the coupons when they make purchases with merchant system 130 through, for example, an e-commerce site or brick and mortar retail location associated with the merchant. Purchases and returns may be recorded by merchant system 130 as merchant transaction information. This information may reflect sale transactions associated with merchant system 130 over a period of time. The merchant transaction information may encompass unique (or substantially unique) identifier information such as, for example, credit card authorization code, an authorization amount, a date and time stamp, a merchant identification number, and a product/service identification number. The credit card authorization code may be issued by financial service provider system 120 or credit card association 150 and used to approve the customer purchase transaction at the time of sale. Merchant system 130 may use the credit card authorization code to verify that the customer has sufficient funds in his account to make the purchase. The authorization amount may include the amount of the total purchase authorized by merchant system 130 (i.e. the total cost). The date and time stamp may reflect the exact date and time of the purchase made by the customer with merchant system 130. Furthermore, each merchant may have a unique merchant identification number and each product and/or service may have a unique identification number (e.g., SKU number).

In one aspect, server 220 may receive merchant transaction information from merchant system 130 periodically (e.g., hourly, daily, monthly, etc.) or in response to a request sent by financial service provider system 120. Financial service provider system 120 may be configured to set up parameters that control which transaction information is provided from merchant system 130 and when that information is to be provided.

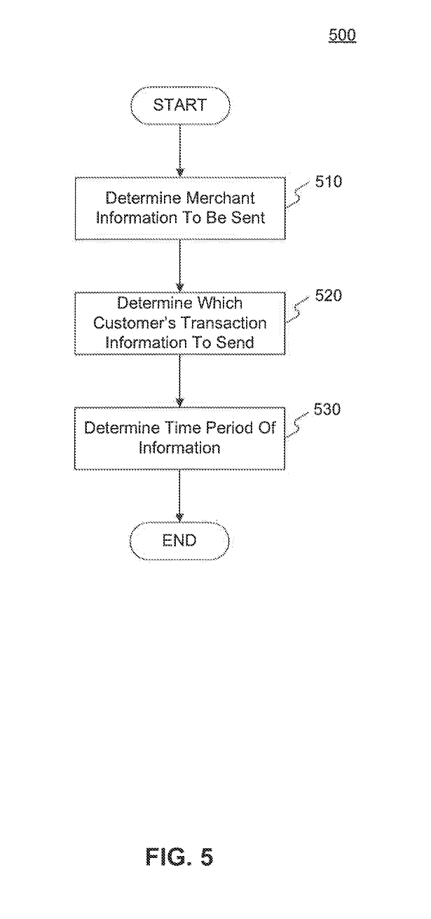

FIG. 5 shows an exemplary process for configuring parameters for sharing transaction information consistent with disclosed embodiments. As shown in FIG. 5, step 510, server 220 may determine which merchant transaction information is sent to financial service provider system 120. For example, in one example, server 220 may configure a process that instructs merchant system 130 to send only one piece of unique identifier information, such as the credit card authorization code for each transaction. Alternatively, server 220 may receive all the merchant transaction information for a specified time period.

Server 220 may additionally determine which customer's transaction information should be sent by merchant system 130. For instance, only the information associated with the customers that received the coupons may be sent to server 220. Therefore, server 220 may configure transaction sharing parameters that instruct merchant system 130 to send merchant transaction information relating to customers that received coupons. Alternatively, server 220 may receive all merchant transaction information for all customers for subsequent filtering in a manner consistent with the disclosed embodiments. In one embodiment, merchant system 130 or another system may determine which customer's transaction should be sent to server 220.

In one aspect, merchant transaction information may reflect sale transactions associated with merchant system 130 over a period of time (e.g., a reporting period). For example, a reporting period may include a day, a week, a month, or a calendar year. Server 220 may determine over which reporting period the relevant merchant transaction information should be sent to server 220. Alternatively, merchant system 130 or another party may determine the reporting period.

Server 220 may store and maintain financial service account transaction information when customers make purchases with financial service provider accounts associated with the financial service provider of provider 120. The financial service accounts transaction information may include information relating to each purchase and return used by the account, such as credit cards. The financial service accounts transaction information may include, for example, an authorization code (e.g., credit card authorization code), an authorization amount, a date and time stamp, a merchant identification number, and a product/service identification number. In one embodiment, financial service provider system 120 may use one or more of this information as unique identifier information.

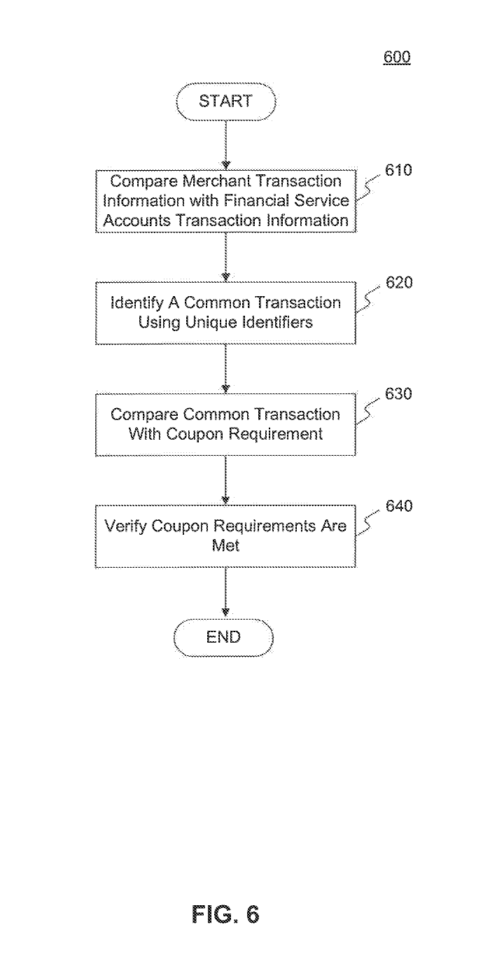

FIG. 6 shows an exemplary verification process 600 consistent with disclosed embodiments. When a customer makes a purchase at merchant system 130 with a financial account associated with financial service provider system 120, server 220 may verify whether that customer's purchase met predetermined credit requirements. Server 220 may compare the received merchant transaction information with the financial accounts transaction information (step 610) within a certain reporting period. Server 220, in step 620, may then identify a common transaction between the merchant transaction information and the financial accounts transaction information using the unique identifier(s). In one aspect, server 220 may execute software processes that analyze the transaction information by comparing the two sets of transaction information using the unique identifier(s). For example, both the merchant transaction information and financial service accounts transaction information may include the same credit card authorization code, authorization amount, date and time stamp, merchant identification number, and/or product/service identification number for a transaction. Server 220 may execute software that identifies that transaction as a common transaction and then uses the financial account transaction information relating to the common transaction to identify the customer and customer financial service account. Thus, for example, server 220 links the common transaction to a customer's financial service account to credit the account.

Server 220 may compare the merchant transaction information and financial service accounts transaction information and identify a common transaction a number of ways. For example, server 220 may search by looking for common authorization amounts, date and time stamps, and/or any of the unique identifiers. Server 220 may use all or only a subset of the unique identifiers to identify a common transaction. Each search may be tailored according to the predetermined credit requirements to maximize efficiency. Server 220 may be configured to determine a confidence value related to identified common transactions. For example, in one aspect, server 220 may use a first subset of unique identifiers (one, two, etc.) to identify a set of common transactions between the merchant and financial service transaction information. This aspect may enable server 220 to perform searching in a more efficient manner. Server 220 may then further filter the first set of common transactions by using a different one or more unique identifiers to identify a single common transaction that relates to both the merchant and financial service account transactions. Server 220 may assign a confidence value with search identified common transaction at each stage of this multi-stage comparison process. If, at any stage, server 220 determines a common transaction meets or exceeds a predetermined confidence level, server 220 may be configured to identify that transaction as the common transaction used to identify the customer and the customer's financial service account.

In one embodiment, when the predetermined credit requirement limits the coupon to specific products, server 220 may first search for common SKU numbers to quickly locate the product common to both transactions. Alternatively or additionally, server 220 may first search for common merchant identification numbers to limit the financial service accounts transaction information to participating merchants. This search may provide useful when server 220 is not informed of the SKU number. Server 220 may parse the matches for common date and time stamps until a common transaction has been located. If no common transaction is located at this time, server 220 may further use all or some of the remaining unique identifiers until the common transaction is located.

In another embodiment, when the coupon predetermined credit requirement limits the coupon to a specific merchant system 130, server 220 may first search for common date and time stamps. In this embodiment it may be unnecessary for server 220 to search for a common merchant identification number because all the merchant transaction information provided to server 220 is from that merchant system 130.

Server 220 may compare the common transaction with the predetermined credit requirement (step 630) and verify the customer met the coupon requirements (step 640). For example, server 220 may confirm that the customer purchased the specific product listed on the coupon, made a purchase at the specific merchant system 130 listed on the coupon, and/or spent the minimum threshold amount listed on the coupon. The merchant transaction information may include such information as product purchased, merchant purchased from, and amount of purchase with each transaction. Therefore, once the common transaction is identified, server 220 may further analyze the merchant transaction information to find the product information, merchant information, and amount associated with the common transaction. Server 220 may then compare this information and/or amount to the coupon predetermined credit requirement. Server 220 may determine that the predetermined credit requirement is satisfied with the customer's purchase.

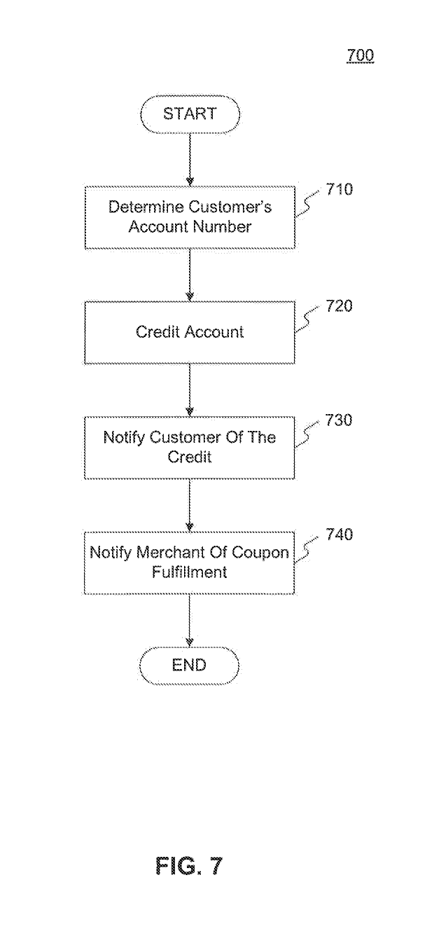

FIG. 7 shows an exemplary coupon fulfillment process consistent with disclosed embodiments. In one aspect, financial service provider system 120 may provide credit to customer financial service accounts that have been used to purchase products or services with a coupon that met the predetermined credit requirement(s). In order to provide credit, server 220 may determine the customer's financial account number based on the common transaction comparison operations described above (step 710). For example, server 220 may identify the customer's financial service account associated with the common transaction. Server 220 may perform processes that credits the identified account (step 720). In one aspect, server 220 may perform processes, or send a command to another computing component (e.g., server, processor, etc.) to include a credit to the customer's account (e.g., add $10 to the credit card balance of a customer's credit card account). Alternative, credit may be applied by transferring a monetary amount equal to the credit into the customer's financial service account (e.g., add $10 to a customer's checking account, savings account, or other types of accounts). The amount is based on the coupon predetermined credit requirement. Alternatively, server 220 may credit the account by deducting service fees associated with the financial service account, or deducting the coupon amount from the purchase price of the product or service before applying the purchase to the customer's account. Other ways of crediting the financial service account may be implemented without departing from the scope of the disclosed embodiments.

Server 220 may notify the customer of the credit to the customer's financial service account (step 730). In one embodiment server 220 may execute software instructions that generate a notification that informs the customer of the credit applied to their account. This may include adding information to the customer's statement that describes the credit, highlights the credit on the statement, etc. Server 220 may also generate the notification in the form of a message (e.g., email, SMS message, mobile application message, etc.). Server 220 may send the notification to the customer using known communication mechanisms (email, SMS messaging, etc.) Additionally or alternatively, server 220 may provide a website for the customer to view any changes in the customer's financial service account by logging in and viewing, for example, an online credit card statement. Furthermore, server 220 may mail a paper notice of the credit, such as a paper credit card statement.

The customer may be unaware of the coupon until the customer receives the notification from server 220. Therefore, system 100 may not require the customer to have the coupon present, be aware of the coupon, or have received the coupon to credit the customer's account. Server 220 may credit the customer's account when the customer has fulfilled the coupon requirements, regardless of the customer's knowledge.

Server 220 may also notify merchant system 130 of coupon fulfillment by the customer (step 740). In one aspect, server 220 may generate the merchant notification in the form of an electronic message or document (e.g., email, link to a website, SMS message, business software mechanisms (ERP, CRM, etc.). Therefore, merchant system 130 may be made aware of the reduced purchase price and may adjust records accordingly. Server 220 may provide the merchant notification through network 110.

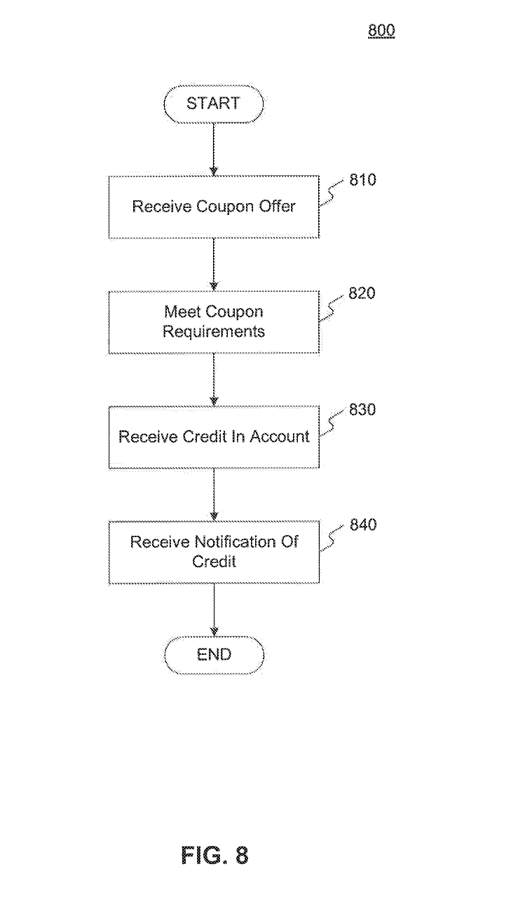

As explained, financial service provider system 120 may provide credit without receiving a customer's restricted information from a merchant. FIG. 8 shows an exemplary process for providing credit according to one embodiment. As shown in FIG. 8, customer device 140 may receive a coupon offer of a specified value with one or more redemption requirements (step 810). The offer may invite the customer to purchase a specific product, make a purchase at a specific merchant system 130, and/or spend a minimum threshold amount to receive a discount on that purchase. Customer device 140 may receive the coupon offer via network 110, e.g., through email, a text, or a mobile app alert, or directly from another component of system 100 (e.g., provider 120). Alternatively, a customer may receive the coupon offer by accessing a website displaying such coupons. Furthermore, the customer may receive a paper coupon offer in the mail.

The customer, as shown by step 820, may meet the coupon requirements by making a purchase that satisfies the redemption requirements. The customer may be required to use the credit card (or other type of account product) associated with a first financial account, with financial service provider system 120, to receive the coupon discount. The customer may then receive a credit (as exemplified above) in the customer's first financial account based on the redemption requirement (step 830). For example, the customer may receive an amount of money transferred into the customer's financial service account. The amount is based on the coupon redemption requirement. Alternatively, the customer's first financial account may only be deducted the purchase amount less the coupon savings.

Customer device 140 may receive a notification of the credit (step 840). The customer may receive an email, text alert, or mobile app alert through network 110. Additionally, customer device 140 may receive notification through access to a website, such as an online credit card statement. Customer device 140 may access the website and display changes to the customer's financial service account that are provided as content from the website. Furthermore, the customer may receive a physical notice of the credit, such as a paper credit card statement.

The exemplary disclosed embodiments describe systems and methods for providing coupon redemption. The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone.

Embodiments of the present disclosure may be implemented through a non-transitory computer readable medium. The medium may store instructions that when executed by one or more processors, performs one or more methods in accordance with the disclosed embodiments. The non-transitory computer readable medium may exist in a server that connects to a device, which in certain embodiments is a mobile device, e.g., a smartphone, a computer tablet, a GPS, a personal digital assistant, a wearable computing device, etc. The mobile device may be owned or otherwise associated with a user. The connection between the mobile device and the server may occur through the Internet or other communication protocols, e.g. Universal Serial Bus (USB), Bluetooth, hardware plug-ins, WiFi and other wireless local area network (WLAN) protocols, and 3G/4G/LTE and other wide area network (WAN) protocols. Certain processes may be performed by mobile device applications, such as an application Internet location (app store). The app store provides an interface through which the customer device 140 may obtain a copy of the software and store the software on a non-transitory computer readable medium on device 140 that when executed by one or more processors provides one or more methods in accordance with the present disclosure described above. The customer device may interact with the app store using an interface executed on the mobile device. In one embodiment, customer device 140 may request a copy of the instructions stored in the app store; the instructions may then be transmitted by the app store to the mobile device. In this manner, as noted above, customer device 140 may itself comprise a non-transitory computer readable medium comprising instructions that when executed by one or more processors provides the systems and methods in accordance with embodiments of the present disclosure described above. Upon execution of the instructions by one or more processors, the mobile device may essentially become a system in accordance with the present disclosure, capable of performing the steps of a method in accordance with the present disclosure.

Other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims.

What is claimed is:

1. A system for providing credit to financial service accounts, comprising:
one or more processors; and
one or more memory devices storing instructions that, when executed by the one or more processors, performs the operations of:
receiving merchant transaction information from a merchant, the merchant transaction information reflecting sale transactions associated with the merchant over a period of time;
comparing the merchant transaction information with financial service accounts transaction information associated with financial service accounts provided by a financial service provider;
identifying a common transaction between the merchant transactions and the financial service accounts transactions based on one or more unique identifiers;
determining the common transaction meets a predetermined credit requirement;
identifying a customer's financial service account corresponding to the common transaction; and
providing credit to the customer's financial service account based on the predetermined requirement.

2. The system of claim 1, wherein the predetermined credit requirement is a coupon requirement corresponding to a coupon associated with the customer's financial service account.

3. The system of claim 2, wherein the instructions, when executed by the one or more processors, performs the operations of:
providing to the customer a notification of the credit to the customer's financial service account.

4. The system of claim 3, wherein the instructions, when executed by the one or more processors, performs the operations of:
providing the notification to the customer after the sales transaction.

5. The system of claim 3, wherein the instructions, when executed by the one or more processors, performs the operations of:
providing to the merchant a notification of the credit to the customer's financial service account.

6. The system of claim 2, wherein the instructions, when executed by the one or more processors, performs the operations of:
providing the credit to the customer's financial service account based on the predetermined credit requirement by crediting the financial service account a monetary amount corresponding to the coupon.

7. The system of claim 2, wherein the instructions, when executed by the one or more processors, performs the operations of:
identifying the common transaction by using the one or more unique identifiers generated with the sale transaction.

8. The system of claim 2, wherein the instructions, when executed by the one or more processors, performs the operations of:
receiving the unique identifiers with the merchant transaction information, wherein the unique identifiers do not indicate the identity of the underlying customer.

9. The system of claim 2, wherein the instructions, when executed by the one or more processors, performs the operations of:
providing credit to the customer's financial service regardless if the customer is aware of the coupon or coupon requirement.

10. The system of claim 2, wherein the instructions, when executed by the one or more processors, performs the operations of:
using different unique identifiers if the coupon refers to a merchant or product specific requirement.

11. A method for providing credit to financial service accounts, comprising:
receiving merchant transaction information from a merchant, the merchant transaction information reflecting sale transactions associated with the merchant over a period of time;
comparing the merchant transaction information with financial service accounts transaction information associated with financial service accounts provided by a financial service provider;
identifying a common transaction between the merchant transactions and the financial service accounts transactions based on one or more unique identifiers;
determining, via one or more processors, the common transaction meets a predetermined credit requirement;
identifying a customer's financial service account corresponding to the common transaction; and
providing credit to the customer's financial service account based on the predetermined requirement.

12. The method of claim 11, wherein the predetermined credit requirement is a coupon requirement corresponding to a coupon associated with the customer's financial service account.

13. The method of claim 12, further including:
providing to the customer a notification of the credit to the customer's financial service account.

14. The method of claim 13, further including:
providing to the merchant a notification of the credit to the customer's financial service account.

15. The method of claim 12, further including:
providing the credit to the customer's financial service account based on the predetermined credit requirement by crediting the financial service account a monetary amount corresponding to the coupon.

16. The method of claim 12, further including:
identifying the common transaction by using the one or more unique identifiers generated with the sale transaction.

17. The method of claim 12, further including:
receiving the unique identifiers with the merchant transaction information, wherein the unique identifiers do not indicate the identity of the underlying customer.

18. The method of claim 12, further including:
providing credit to the customer's financial service regardless if the customer is aware of the coupon or coupon requirement.

19. The method of claim 12, further including:
using different unique identifiers if the coupon refers to a merchant or product specific requirement.

20. A system for receiving notification of a credit to a financial service account, comprising:
a memory device storing instructions; and
a processor configured to execute the instructions to:
receive a financial offer of a specified value, the financial offer including redemption requirements; and
receive a notification of a credit, wherein
the credit was applied to a first financial account based on a qualifying purchase of an item from a merchant using the first financial account,
the notification became generated based on a comparison between merchant transaction information provided by the merchant with financial service accounts transaction information associated with financial service accounts provided by a financial service provider, the financial service accounts including:
the first financial account, an identification of a common transaction between the merchant transaction and the financial service accounts transactions based on one or more unique identifiers, a determination that the common transactions meets the redemption requirements, and an identification of the first financial account based on the identification of the common transactions.
